(19) United States
(12) Patent Application Publication
(10) Pub. No.: US 2018/0267646 A1
(43) Pub. Date: Sep. 20, 2018

(54) TOUCH SCREEN AND DISPLAY DEVICE CONTAINING THE SAME

(71) Applicants: BOE TECHNOLOGY GROUP CO., LTD., Beijing (CN); HEFEI BOE OPTOELECTRONICS TECHNOLOGY CO., LTD., Hefei , Anhui (CN)

(72) Inventors: Xianjie Shao, Beijing (CN); Xianxi Cui, Beijing (CN)

(73) Assignees: BOE TECHNOLOGY GROUP CO., LTD., Beijing (CN); HEFEI BOE OPTOELECTRONICS TECHNOLOGY CO., LTD., Hefei , Anhui (CN)

(21) Appl. No.: 15/761,388

(22) PCT Filed: Mar. 21, 2017
(86) PCT No.: PCT/CN2017/077433

§ 371 Date: Mar. 19, 2018

(30) Foreign Application Priority Data
Aug. 4, 2016 (CN) 201610634763.0

(51) Int. Cl. G06F 3/044; G06F 3/041

(52) U.S. Cl. CPC G06F 3/044; G06F 2203/04112; G06F 3/0412

(57) ABSTRACT

The present application discloses a touch screen, including: a first touch electrode and a second touch electrode in a same layer as the second touch electrode surrounding the first touch electrode. An outer periphery of the first touch electrode is separated from an inner periphery of the second touch electrode.

### CROSS-REFERENCE TO RELATED APPLICATION

This PCT application claims priority to Chinese Patent Application No. 201610634763.0, filed on Aug. 4, 2016, the entire contents of which are incorporated herein by reference.

### TECHNICAL FIELD

The present disclosure generally relates to the display technologies and, more particularly, to a touch screen and a display device containing the touch screen.

### BACKGROUND

With the rapid development of display technology, touch screen panels are widely used in people's life. Currently, based on the structures, touch screen panels mainly have three types, add-on mode touch panels, on-cell touch panels, and in-cell touch panels. To fabricate an add-on mode touch panel, the touch panel and the liquid crystal display (LCD) panel are fabricated separately and then bonded together. An LCD panel with touch functions can be formed. An add-on mode touch panel is often expensive to fabricate and has a relatively low light transmission rate, and has a relatively thick module. In an in-cell touch panel touch electrodes are often embedded in the LCD display. Accordingly, the touch screen of an in-cell touch panel has a thinner overall thickness and the manufacturing cost of the touch screen is lower.

### SUMMARY

In one aspect, the present disclosure provides a touch screen, including: a first touch electrode and a second touch electrode in a same layer as the second touch electrode surrounding the first touch electrode. An outer periphery of the first touch electrode is separated from an inner periphery of the second touch electrode.

Optionally, the first touch electrode and the second electrode are insulated from one another.

Optionally, the first touch electrode comprises a plurality of sub-touch electrodes surrounded by the second touch electrode.

Optionally, an outer periphery of one of the plurality of sub-touch electrodes comprises at least one of a curved shape, a broken-line shape, a protruding shape, or a recess shape.

Optionally, the one of the plurality of sub-touch electrodes comprises portions interleaving with portions of the second touch electrode.

Optionally, the plurality of sub-touch electrodes is substantially of a same shape.

Optionally, the plurality of sub-touch electrodes is of a “ [symbol] ” shape.

Optionally, at least two of the plurality of sub-touch electrodes have different shapes.

Optionally, the first touch electrode comprises a touch-drive electrode and the second touch electrode comprises a touch-sense electrode.

Optionally, the first touch electrode comprises a touch-sense electrode and the second touch electrode comprises a touch-drive electrode.

Optionally, the touch screen further includes a first substrate opposing a second substrate, wherein the first touch electrode and the second touch electrode are arranged on a light-emitting side of the first substrate.

Optionally, the first substrate comprises a color filter substrate and the second substrate comprises an array substrate.

Optionally, the touch screen further includes: a polarizer layer disposed over the first touch electrode and the second touch electrode; and a cover panel bonded to the polarizer layer through an optically-transparent glue layer.

Another aspect of the present disclosure provides a display device, including the disclosed touch screen.

### BRIEF DESCRIPTION OF THE FIGURES

The following drawings are merely examples for illustrative purposes according to various disclosed embodiments and are not intended to limit the scope of the present disclosure.

FIG. 1 illustrates a structure of a conventional touch screen;

FIG. 2 illustrates the working principle of a conventional touch screen;

FIG. 3 illustrates an exemplary structure of an exemplary touch screen according to the disclosed embodiments of the present disclosure; and

FIG. 4 illustrates a cross-sectional view of the touch screen shown in FIG. 3.

### DETAILED DESCRIPTION

Exemplary embodiments will now be described in more detail with reference to the drawings. It is to be noted that the following descriptions of some embodiments are presented herein for purpose of illustration and description only. It is not intended to be exhaustive or to be limited to the precise form disclosed.

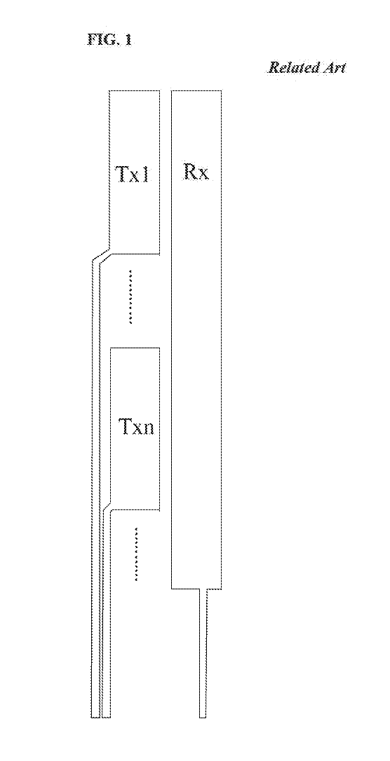

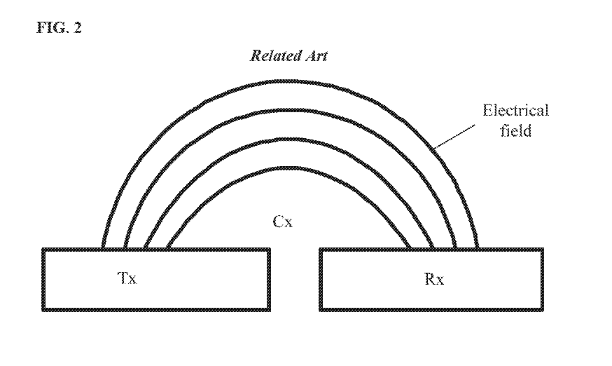

FIG. 1 illustrates the structure of a conventional touch screen, and FIG. 2 illustrates the working principle of the conventional touch screen. As shown in FIGS. 1 and 2, a node capacitance Cx is formed between a touch-drive electrode Tx and a touch-sense electrode Rx. When a finger tip touches the touch screen, the electrical field between the touch-drive electrode Tx and the touch-sense electrode Rx changes, causing the node capacitance Cx to change. By detecting the change of Cx after the touch, the location of the touch point can be detected. However, in a conventional in-cell touch panel, the node capacitance formed between a touch-drive electrode Tx and a touch-sense Rx is relatively small, and thus the change of the Cx caused by a touch is small. As a result, the sensitivity of the touch screen and the signal to noise ratio of the touch screen are reduced. The precision of touch sensing of a conventional touch screen is impaired.

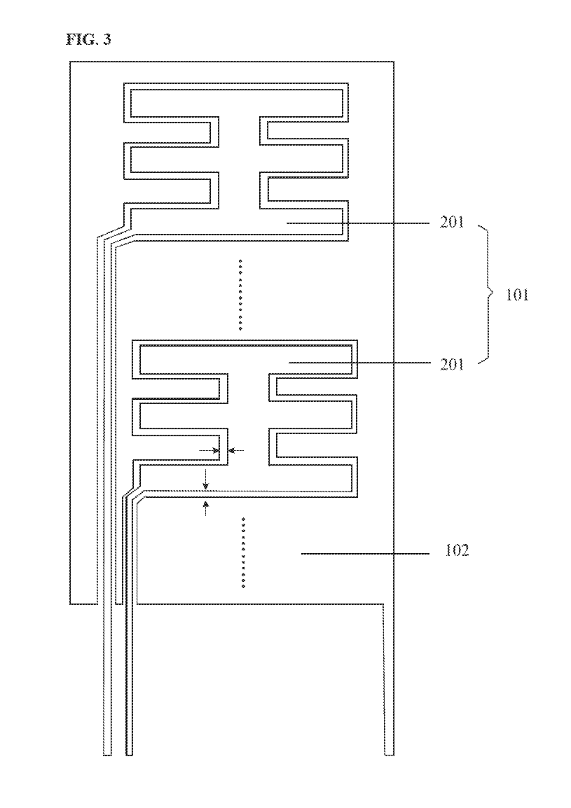

FIG. 3 illustrates a structure of an exemplary touch screen provided by the present disclosure. The touch screen may include a plurality of first touch electrodes 101 and a plurality of second touch electrodes 102. The first touch electrodes 101 and the second touch electrodes 102 can be arranged in a same layer and can be formed by, e.g., patterning a conducting material layer. To simplify illustration, FIG. 3 only shows one first touch electrode 101 and one second touch electrode 102. As shown in FIG. 3, the first touch electrode 101 includes a plurality of sub-touch electrodes 201. The sub-touch electrodes 201 are arranged in the second touch electrode 102. That is, as shown in FIG. 3, an outer periphery of a sub-touch electrode 201 is surrounded by an inner periphery of the second touch electrode 102. The outer periphery of a sub-touch electrode 201 may be separated from the inner periphery of the second touch electrode 102 that faces the sub-touch electrode 201 by a preset distance, indicated by the space between a pair of arrows in FIG. 3. In some embodiments, by arranging the sub-touch electrodes 201 and the second touch electrodes 102, for example, in the same layer, the opposing area between the outer side of a sub-touch electrode 201 and the inner side of the second touch electrode 102 surrounding the sub-touch electrode 201 may be larger. In the present disclosure, term “surround”, “surrounding”, and the like refer to one object entirely or partially encompassing or enclosing another object. For example, an outer periphery of a sub-touch electrode 201 being surrounded by an inner periphery of the second touch electrode 102 refers to that the inner periphery of the second touch electrode 102 partially or entirely encompassing the outer periphery of the sub-touch electrode 201.

In some embodiments, the outer periphery of the sub-touch electrode 201 and the inner periphery of the second touch electrode 102 surrounding the sub-touch electrode 201 may be separated by a certain preset distance such that the first touch electrode 101 including the sub-touch electrode 201 and the second touch electrode 102 surrounding the first touch electrode 101 may be insulated from each other. Thus, the opposing area between the first touch electrode 101 and the second touch electrode 102 may be increased. The opposing area may be the non-contact overlapping area between the outer periphery of a sub-touch electrode 201 and a corresponding inner periphery of the second touch electrode 102. i.e., the opposing area between the outer side/area of the sub-touch electrode 201 and the corresponding inner side/area of the second touch electrode 102, neighboring the sub-touch electrode 201. Compared with the structure shown in FIG. 1, where only one side of a touch-drive electrode Tx is opposing or facing a touch-sense electrode Rx in a touch screen, in the touch screen illustrated in FIG. 3, the entire outer periphery of a first touch electrode 101 may be opposing a corresponding second touch electrode 102. Thus, the opposing area between the first touch electrode 101 and the second touch electrode 102 surrounding the first touch electrode 101 may be increased.

The capacitance of a capacitor can be calculated using C=εS/4πkd, where C represents the capacitance. ε represents a constant, e.g., a dielectric constant of the substance between plates of the capacitor, S represents the opposing area between the plates of the capacitor, d represents the distance between the plates, and k represents the electrostatic constant. That is, at the same distance d, a greater opposing area S can result in a greater capacitance. Thus, according to present disclosure, given the same layout area as in the conventional technologies, the node capacitance formed between the first touch electrode 101 and the corresponding second touch electrode 102 consistent with the present disclosure may be greater, such that when a finger tip touches the touch screen, the change of the node capacitance caused by the touch can be increased. Also, the distance d between the plates, which represent the preset distance between the outer periphery of the sub-touch electrode 201 and the inner periphery, surrounding the sub-touch electrode 201, of the corresponding second touch electrode 102, may be adjusted to obtain a desired capacitance C. That is, the distance d between the outer periphery of the sub-touch electrode 201 and the inner periphery of the corresponding second touch electrode 102 may be constant or may vary. For example, the distance d may be the same for a plurality of sub-touch electrodes 102 surrounded by one second touch electrode 102, or may be different for different sub-touch electrodes 102. The distance d may also be variant for one sub-touch electrode 102. The specific value of the distance d can be determined according to actual applications/designs and should not be limited by the embodiments of the present disclosure. The touch screen may thus have a higher sensitivity. The precision of the touch sensing may be improved.

In some embodiments, the outer periphery of a sub-touch electrode 201 may be of a curved shape. In some other embodiments, the outer periphery of a sub-touch electrode 201 may have a broken-line shape, a protruding shape, a recess shape, and/or other suitable shapes. The outer periphery of a sub-touch electrode 201 may also have a combination of the aforementioned different shapes or other irregular shapes. These shapes may increase the opposing area between the outer periphery of a sub-touch electrode 201 and the corresponding second touch electrode 102, and thus increase the opposing area between the first touch electrode 101 and the second touch electrode 102 surrounding the first touch electrode 101. Accordingly, given a same layout area as in the conventional technologies, the opposing area between the first touch electrode 101 and the second touch electrode 102 surrounding the first touch electrode 101 consistent with the present disclosure may be increased and the node capacitance formed between the first touch electrode 101 and the second touch electrode 102 may be increased. Thus, when a finger tip touches the touch screen, the change of the node capacitance caused by the touch can be increased. The touch screen may thus have a higher sensitivity. The precision of the touch sensing may be improved. Further, the disclosed technical solution may also increase the amplitude of touch signals and the signal to noise ratio of the touch signals. Touch effect may be more precise, and the touch screen may be more suitable for large-size display products.

In various embodiments, the shapes or overall shapes of sub-touch electrodes 201 in the first touch electrode 101 may be substantially the same or different, and shapes of sub-touch electrodes 201 surrounded by different second touch electrodes 201 may be substantially the same or different. For example, a second touch electrode 102 may surround one first touch electrode 101 including sub-touch electrodes 201 of different shapes/overall shapes. The specific shapes of the sub-touch electrodes 201 can be determined based on actual fabrication/design needs, e.g., desired node capacitance, and should not be limited by the embodiments of the present disclosure. For example, a sub-touch electrode 201 can have portions that interleaving with portions of the second touch electrode 102.

In one example, as shown in FIG. 3, the sub-touch electrodes 201 have substantially the same shape, i.e., a “ [symbol] ” shape. Compared to the conventional technologies, the “ [symbol] ” shape of the sub-touch electrodes 201 may increase the opposing area between the first touch electrode 101 and the corresponding second touch electrode 102. In various other embodiments, the sub-touch electrodes 201 may also have one or more different shapes. The specific shape of a sub-touch electrode 201 can be determined according to the specific applications and/or design requirements and should not be limited by the embodiments of the present disclosure. As an example, Table 1 shows simulation results of a touch screen having the “ [symbol] ”-shaped sub-touch electrodes and the comparison with the conventional technologies.

| | Conventional | |
|---|---|---|
| Measured item | technologies | Present disclosure |
| Node capacitance (pf) | 1.3 | 3.15 |
| Absolute amount of signal change | 0.17 | 0.65 |
| (pf) | | |
| Percentage of signal change (%) | 13.1% | 20.6% |
| Signal-to-noise ratio (dB) | 33.02 | 45.91 |

As shown in Table 1, compared to the conventional technologies, with the same height and width of a touch area, the opposing area between a first touch electrode and a corresponding second touch electrode consistent with the present disclosure can be increased by about 300%. That is, the node capacitance provided by the structure consistent with the present disclosure can be increased by about three times as compared to the conventional technology. Meanwhile, the absolute amount of signal change and the percentage of signal change have been improved in the present disclosure. That is, a finger tip may have a higher impact on the change of touch signals when touching the touch screen. Thus, the sensitivity of the touch screen may be improved, and the precision of the touch sensing may be improved. Further, the absolute amount of signal change and signal-to-noise ratio may be increased by using the disclosed technical solution. The disclosed touch screen may have touch effect of a higher precision and may be used in large-size display products.

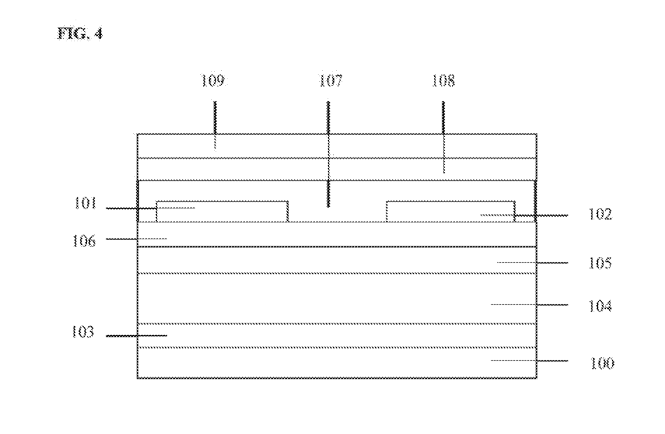

In some embodiments, the first touch electrode 101 may be a touch-drive electrode, and the second touch electrode 102 may be a touch-sense electrode. In some other embodiments, the second touch electrode 102 may be a touch-drive electrode, and the first touch electrode 101 may be a touch-sense electrode. Further, the display screen may include a first substrate and a second substrate, opposing/facing each other. The first touch electrodes 101 and the second touch electrodes 102 may be arranged on the light-emitting side of the first substrate. In some embodiments, the first substrate may be a color filter substrate, and the second substrate may be an array substrate. FIG. 4 illustrates a cross-sectional view of the touch screen shown in FIG. 3. As shown in FIG. 4, the touch screen includes an array substrate 100, a thin-film transistor (TFT) layer 103 arranged over the array substrate 100, a color filter layer 105 arranged over the TFT layer 103, and a color filter substrate 106 arranged over the color filter layer 105. The TFT layer 103 may include a plurality of TFTs, and the color filter layer 105 may include a plurality of color filters. A liquid crystal layer 104 is sandwiched between the color filter layer 105 and the TFT layer 103. The first touch electrodes 101 and the second touch electrodes 102 are disposed on the light-emitting side of the color filter substrate 106. A polarizer layer 107 is arranged over the first touch electrodes 101 and the second touch electrodes 102. An optically-transparent glue 108 is disposed over the polarizer layer 107, and a cover panel 109 is disposed over the optically-transparent glue 108.

The present disclosure provides a touch screen. The touch screen may include a plurality of first touch electrodes and a plurality of second touch electrodes. A first touch electrode may include a plurality of sub-touch electrodes. A sub-touch electrode may be arranged in, i.e., surrounded by, a second touch electrode. The sub-touch electrodes and the second touch electrodes may be arranged in a same layer. For example, the sub-touch electrodes and the second touch electrodes may be formed through a same fabrication step. An outer periphery of a sub-touch electrode may be separated from an inner periphery of the second touch electrode surrounding the sub-touch electrode by a preset distance. In the present disclosure, a first touch electrode may include a plurality of sub-touch electrodes, and the plurality of sub-touch electrodes may be arranged in a second touch electrode. By forming a preset distance between the outer periphery of a sub-touch electrode and an inner periphery of the second touch electrode surrounding the sub-touch electrode, the opposing area between first touch electrode including the sub-touch electrode and the second touch electrode surrounding the first touch electrode may be increased. Thus, a higher node capacitance may be formed between the first touch electrodes and the corresponding second touch electrodes within a same touch area. That is, a finger tip may have a higher impact on the change of touch signals when touching the touch screen. Thus, the sensitivity of the touch screen may be improved, and the precision of the touch sensing may be improved. Further, the absolute amount of signal change and signal-to-noise ratio may be increased by using the disclosed technical solution. The disclosed touch screen may have a touch effect of a higher precision and may be used in large-size display products.

The present disclosure further provides a display device including one or more touch screens consistent with the disclosure, such as one or more of the above-described exemplary touch screens. The above description can be referred to for details of the touch screen, including its structure and functions.

In the display device provided by the present disclosure, the touch screen may include a plurality of first touch electrodes and a plurality of second touch electrodes. A first touch electrode may include a plurality of sub-touch electrodes. A sub-touch electrode may be arranged in, i.e., surrounded by, a second touch electrode. The sub-touch electrodes and the second touch electrodes may be arranged in a same layer. For example, the sub-touch electrodes and the second touch electrodes may be formed through a same fabrication step. An outer periphery of a sub-touch electrode may be separated from an inner periphery of the second touch electrode surrounding the sub-touch electrode by a preset distance. In the present disclosure, a first touch electrode may include a plurality of sub-touch electrodes, and the plurality of sub-touch electrodes may be arranged in a second touch electrode. By forming a preset distance between the outer periphery of a sub-touch electrode and an inner periphery of the second touch electrode surrounding the sub-touch electrode, the opposing area between first touch electrode including the sub-touch electrode and the second touch electrode surrounding the first touch electrode may be increased. Thus, a higher node capacitance may be formed between the first touch electrodes and the corresponding second touch electrodes within a same touch area. That is, a finger tip may have a higher impact on the change of touch signals when touching the touch screen. Thus, the sensitivity of the touch screen may be improved, and the precision of the touch sensing may be improved. Further, the absolute amount of signal change and signal-to-noise ratio may be increased by using the disclosed technical solution. The disclosed touch screen may have a touch effect of a higher precision and may be used in large-size display products.

The foregoing description of the embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to persons skilled in this art. The embodiments are chosen and described in order to best explain the principles of the technology, with various modifications suitable to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to exemplary embodiments of the disclosure does not imply a limitation on the disclosure, and no such limitation is to be inferred. Moreover, the claims may refer to “first”, “second”, etc. followed by a noun or element. Such terms should be understood as a nomenclature and should not be construed as giving the limitation on the number of the elements modified by such nomenclature unless specific number has been given. Any advantages and benefits described may or may not apply to all embodiments of the disclosure. It should be appreciated that variations may be made in the embodiments described by persons skilled in the art without departing from the scope of the present disclosure as defined by the following claims. Moreover, no element or component in the present disclosure is intended to be dedicated to the public regardless of whether the element or component is explicitly recited in the following claims.

1. A touch screen, comprising:
a first touch electrode and a second touch electrode in a same layer as the second touch electrode surrounding the first touch electrode,
wherein an outer periphery of the first touch electrode is separated from an inner periphery of the second touch electrode.

2. The touch screen according to claim 1, wherein the first touch electrode and the second electrode are insulated from one another.

3. The touch screen according to claim 1, wherein the first touch electrode comprises a plurality of sub-touch electrodes surrounded by the second touch electrode.

4. The touch screen according to claim 3, wherein an outer periphery of one of the plurality of sub-touch electrodes comprises at least one of a curved shape, a broken-line shape, a protruding shape, or a recess shape.

5. The touch screen according to claim 4, wherein the one of the plurality of sub-touch electrodes comprises portions interleaving with portions of the second touch electrode.

6. The touch screen according to claim 4, wherein the plurality of sub-touch electrodes is substantially of a same shape.

7. The touch screen according to claim 6, wherein the plurality of sub-touch electrodes is of a “ [symbol] ” shape.

8. The touch screen according to claim 4, wherein at least two of the plurality of sub-touch electrodes have different shapes.

9. The touch screen according to claim 1, wherein the first touch electrode comprises a touch-drive electrode and the second touch electrode comprises a touch-sense electrode.

10. The touch screen according to claim 1, wherein the first touch electrode comprises a touch-sense electrode and the second touch electrode comprises a touch-drive electrode.

11. The touch screen according to claim 1, further comprising a first substrate opposing a second substrate, wherein the first touch electrode and the second touch electrode are arranged on a light-emitting side of the first substrate.

12. The touch screen according to claim 11, wherein the first substrate comprises a color filter substrate and the second substrate comprises an array substrate.

13. The touch screen according to claim 12, further comprising:
a polarizer layer disposed over the first touch electrode and the second touch electrode; and
a cover panel bonded to the polarizer layer through an optically-transparent glue layer.

14. A display device, comprising the touch screen according to claim 1.
